(19) United States
(12) Patent Application Publication
(10) Pub. No.: US 2011/0139858 A1
(43) Pub. Date: Jun. 16, 2011

(54) CARRIER FOR MANUFACTURING SUBSTRATE AND METHOD OF MANUFACTURING SUBSTRATE USING THE SAME

(76) Inventors: Seong Min Cho, Gyenggi-do (KR); Keung Jin Sohn, Gyunggi-do (KR); Chang Gun Oh, Gyunggi-do (KR); Hyun Jung Hong, Gyunggi-do (KR); Tae Kyun Bae, Gyunggi-do (KR)

(21) Appl. No.: 12/721,544

(22) Filed: Mar. 10, 2010

(30) Foreign Application Priority Data
Dec. 15, 2009 (KR) 10-2009-0124707

(51) Int. Cl. B23K 31/02; B32B 15/01

(52) U.S. Cl. 228/176; 428/686; 428/646; 428/645; 428/657; 428/658; 428/642; 428/650; 428/674; 428/680

(57) ABSTRACT

Disclosed herein is a carrier for manufacturing a substrate, including: two insulation layers, each being provided on one side thereof with a first metal layer and on the other side thereof with a second metal layer; and a third metal layer having a lower melting point than the first metal layer and formed between the two first metal layers respectively formed on the two insulation layers such that the two first metal layers are attached to each other. The carrier is advantageous in that the carrier can be separated by heating the third metal layer, so that the size of a substrate does not change at the time of separating the carrier, thereby maintaining the compatibility between a substrate and manufacturing facilities.

### CROSS REFERENCE TO RELATED APPLICATION

This application claims the benefit of Korean Patent Application No. 10-2009-0124707, filed Dec. 15, 2009, entitled “A carrier member for manufacturing a substrate and a method of manufacturing a substrate using the same”, which is hereby incorporated by reference in its entirety into this application.

### BACKGROUND OF THE INVENTION

1. Technical Field

The present invention relates to a carrier for manufacturing a substrate and a method of manufacturing a substrate using the same.

2. Description of the Related Art

Generally, printed circuit boards (PCBs) are manufactured by patterning one or both sides of a substrate, composed of various thermosetting resins, using copper foil, and disposing and fixing ICs or electronic parts on the substrate to form an electric circuit and then coating the substrate with an insulator.

Recently, with the advancement of the electronics industry, electronic parts are increasingly required to be highly functionalized, light, thin, short and small. Thus, printed circuit boards loaded with such electronic parts are also required to be highly densified and thin.

In particular, in order to keep up with the thinning of printed circuit boards, a coreless substrate which can decrease thickness by removing a core and can shorten signal processing time is attracting considerable attention. However, a coreless substrate needs a carrier serving as a support during a process because it does not have a core. Hereinafter, a conventional method of manufacturing a coreless substrate will be described with reference to FIGS. 1A to 1E.

FIGS. 1A to 1E are sectional views sequentially showing a conventional method of manufacturing a substrate using a carrier. Problems of conventional technologies will be described with reference to FIGS. 1A to 1E.

First, as shown in FIG. 1A, a carrier 10 is provided. The carrier 10 is fabricated by sequentially forming adhesive films 12, first metal layers 13 and second metal layers 14 on both sides of a copper clad laminate (CCL) 11. In this case, the carrier is heated and pressed by a press, and thus the copper clad laminate 11 and the second metal layer 14 attach to each other at a periphery thereof by means of the adhesive film 12. Meanwhile, in order to stably attach the copper clad laminate 11 and the second metal layer 14 to each other, the contact face therebetween must have a thickness of 10 mm, and the first metal layer 13 and the second metal layer are vacuum-adsorbed.

Subsequently, as shown in FIG. 1B, build up layers 15 are formed on both sides of the carrier 10. Here, each of the build up layers 15 is formed in a general manner, and is additionally provided with a third metal layer 16 for preventing the warpage of the build up layer 15 at the outermost layer thereof.

Subsequently, as shown in FIG. 1C, the build up layers 15 are separated from the carrier 10. Here, the build up layers 15 are separated from the carrier 10 by removing the edge of the adhesive film through which the copper clad laminate 11 and the second metal layer 14 are attached to each other by a routing process.

Subsequently, as shown in FIG. 1D, the second metal layer 14 and the third metal layer 15 formed at the outermost layers of the build up layer 15 are removed by etching.

Subsequently, as shown in FIG. 1E, openings 17 for exposing pads 19 are formed in the outermost insulation layers of the build up layer 15, and then solder balls 18 are formed on the pads 19.

In this conventional substrate manufacturing method, the build up layer 15 must be finally separated from the carrier 10. However, since both edges of the carrier 10 are removed through a routing process during this separation procedure, the size of the carrier 10 is decreased, and thus it is difficult to reuse the carrier 10. Therefore, the conventional substrate manufacturing method is problematic in that the carrier 10 must be additionally provided whenever a printed circuit board is manufactured, thus increasing the production cost of the printed circuit board. Further, the conventional substrate manufacturing method is problematic in that it is difficult to maintain the compatibility between a substrate and a manufacturing facility because the size of the substrate is changed by a routing process.

Furthermore, the conventional substrate manufacturing method is problematic in that the build up layer 15 can be arbitrarily separated from the carrier 10 because the build up layer 15 is actually fixed on the carrier 10 by only the adhesion force of the edge of the adhesive film 12.

### SUMMARY OF THE INVENTION

Accordingly, the present invention has been made to solve the above-mentioned problems, and the present invention provides a carrier for manufacturing a substrate, which can be easily separated by heating a metal layer having a relatively low melting point without performing a routing process and which can be used as an insulation layer or circuit layer of a finally-produced printed circuit board, and a method of manufacturing a substrate using the same.

An aspect of the present invention provides a carrier for manufacturing a substrate, including: two insulation layers, each being provided on one side thereof with a first metal layer and on the other side thereof with a second metal layer; and a third metal layer having a lower melting point than the first metal layer and formed between the two first metal layers respectively formed on the two insulation layers such that the two first metal layers are attached to each other.

Here, the third metal layer may be made of tin or a tin alloy.

Further, the third metal layer may be made of any one selected from the group consisting of tin, cadmium, lead, bismuth, zinc, and alloys or combinations thereof.

Further, the first metal layer may be made of copper, nickel or aluminum.

Further, the insulation layer may be formed of prepreg or ABF (Ajinomoto Build up Film).

Further, intermetallic compound layers may be formed between the third metal layer and the first metal layers.

Another aspect of the present invention provides a method of manufacturing a substrate using a carrier, comprising: providing two insulation layers, each being provided on one side thereof with a first metal layer and on the other side thereof with a second metal layer; forming a third metal layer having a lower melting point than the first metal layer between the two first metal layers respectively formed on the two insulation layers such that the two first metal layers are attached to each other, so as to provide a carrier; forming a build up layer on the exposed surface of the second metal layer; and heating the third metal layer to its melting point or higher to separate the carrier.

Here, in the forming of the third metal layer, the third metal layer may be made of tin or a tin alloy.

Further, in the forming of the third metal layer, the third metal layer may be made of any one selected from the group consisting of tin, cadmium, lead, bismuth, zinc, and alloys or combinations thereof.

The method of manufacturing a substrate using a carrier may further include: removing the third metal layer remaining on the first metal layers after the separating of the carrier.

The method of manufacturing a substrate using a carrier may further include: patterning the first metal layer to form a first circuit pattern after the separating of the carrier.

The method of manufacturing a substrate using a carrier may further include: removing the first metal layer and then forming a first circuit pattern through a plating process after the separating of the carrier.

The method of manufacturing a substrate using a carrier may further include: patterning the second metal layer to form a second circuit pattern after the forming of the third metal layer.

Further, the forming of the third metal layer may include: plating the third metal layers on the two first metal layers formed on the two insulation layers, respectively; and heating and pressing the third metal layers plated on the two first metal layers to attach them to each other, thereby providing the carrier.

Further, the forming of the third metal layer may include: plating the third metal layer on any one of the two first metal layers formed on the two insulation layers; and heating and pressing the third metal layer plated on one first metal layer and the other first metal layer to attach them to each other, thereby providing the carrier.

Further, the forming of the third metal layer may include: heating and pressing the foil-shaped third metal layers to apply them on the two first metal layers formed on the two insulation layers; and heating and pressing the third metal layers applied on the two first metal layers to attach them to each other, thereby providing the carrier.

Further, the forming of the third metal layer may include: heating and pressing the foil-shaped third metal layer to apply it on either of the two first metal layers formed on the two insulation layers; and heating and pressing the third metal layer applied on one first metal layer and the other first metal layer to attach them to each other, thereby providing the carrier.

Further, in the providing of the two insulation layers, the first metal layer may be made of copper, nickel or aluminum.

Further, in the providing of the two insulation layers, the first metal layer may be formed of prepreg or ABF (Ajinomoto Build up Film).

Further, in the forming of the third metal layer, intermetallic compound layers may be formed between the third metal layer and the first metal layers.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIGS. 1A to 1E are sectional views sequentially showing a conventional method of manufacturing a substrate using a carrier;

FIG. 2 is a sectional view showing a carrier for manufacturing a substrate according to an embodiment of the present invention; and

FIGS. 3 to 10 are sectional views sequentially showing a method of manufacturing a substrate using the carrier according to an embodiment of the present invention.

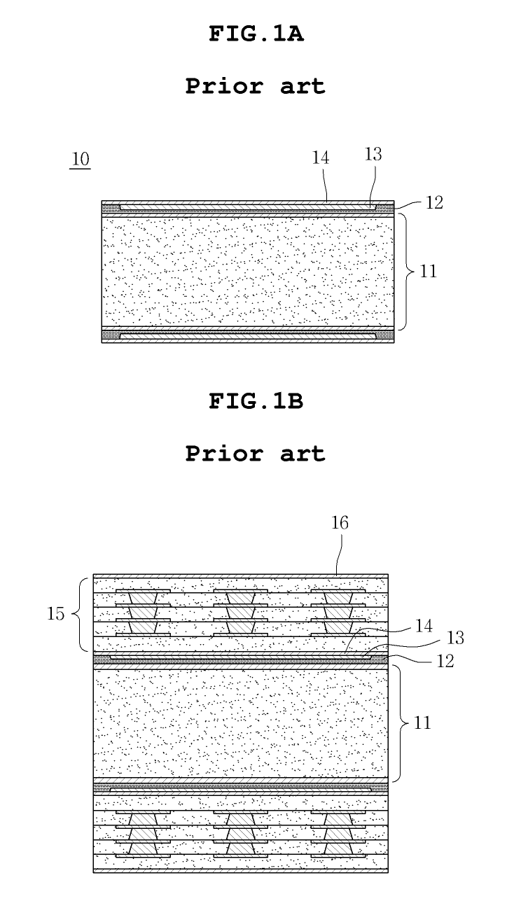

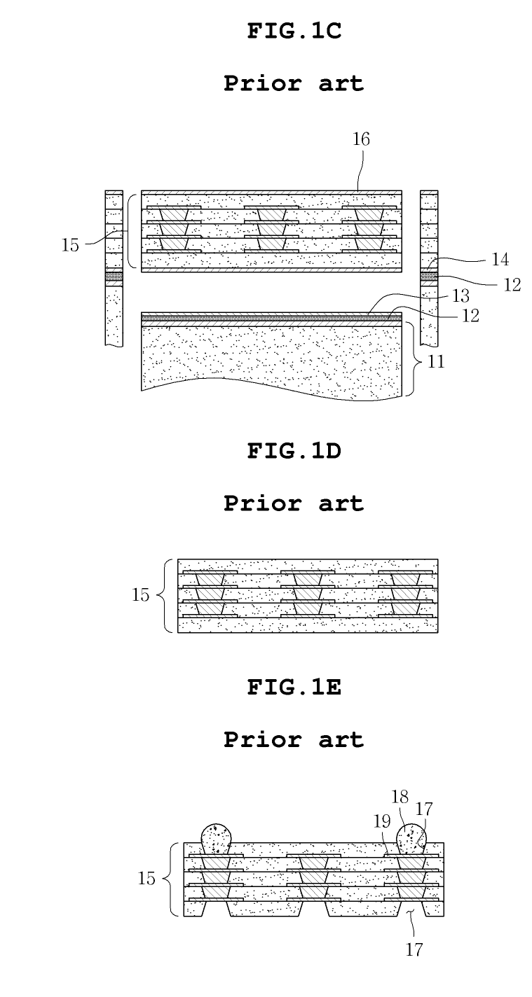

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, in the following description, the terms “one side”, “the other side”, “first”, “second”, “third” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

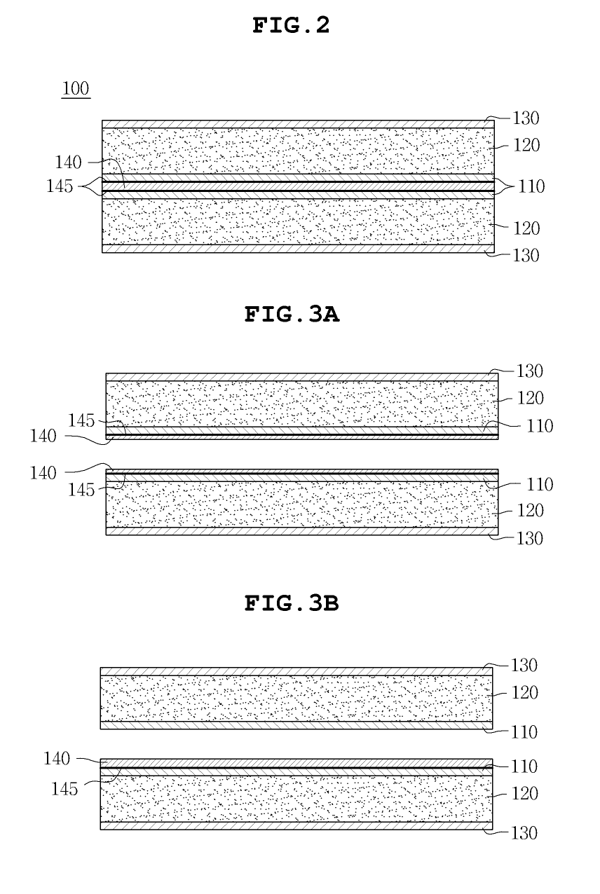

FIG. 2 is a sectional view showing a carrier for manufacturing a substrate according to an embodiment of the present invention.

As shown FIG. 2, a carrier 100 for manufacturing a substrate according to an embodiment of the present invention includes: two insulation layers 120, each being provided on one side thereof with a first metal layer 110 and on the other side thereof with a second metal layer 130; and a third metal layer 140 having a lower melting point than the first metal layer 110 and formed between the two first metal layers 110 respectively formed on the two insulation layers 120 such that the two first metal layers 110 are attached to each other.

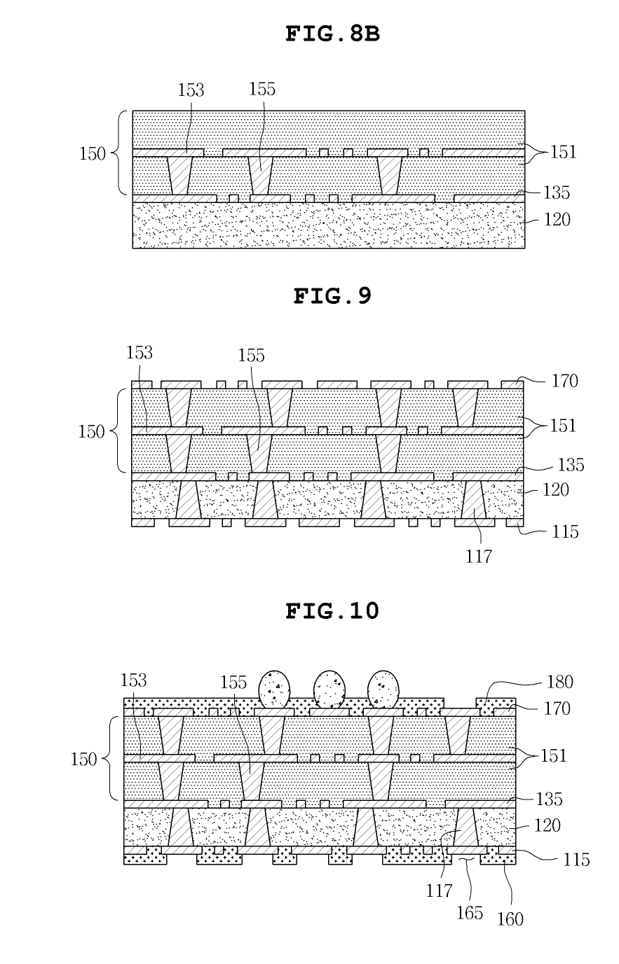

Since each of the first metal layers 110 serves as a support of the carrier 100, each of the first metal layers 110 must have bearing resistance of predetermined strength or more in order to prevent the warpage of the carrier 100 and must have a higher melting point than the third metal layer 140 which is melted at the time of separating the carrier 100. Considering the above bearing resistance and melting point, each of the first metal layers 110 may be made of copper, nickel or aluminum. For reference, a metal, such as tin, cadmium, lead, bismuth, zinc or the like, constituting the third metal layer 140, has a melting point ranging from about 232° C. to about 419° C. (tin: about 232° C., cadmium: about 320.9° C., lead: about 327° C., bismuth: about 271.3° C., zinc: about 419° C.), whereas a metal, such as copper, nickel or aluminum, constituting each of the first metal layers 110, has a melting point ranging from about 660° C. to about 1455° C. (copper: about 1083° C., nickel: about 1455° C., aluminum: about 660° C.). Therefore, at the time of separating the carrier 100, when the carrier 100 is heated to a predetermined temperature (for example, a temperature ranging from 419° C. or more to less than 660° C.), the third metal layer 140 alone can be selectively melted without phase-changing each of the first metal layers 110. Meanwhile, since each of the first metal layers 110 can be patterned to form a first circuit pattern 115 (refer to FIG. 8A), it is more preferred that each of the first metal layers 110 be made of copper.

Each of the second metal layers 130, similarly to each of the first metal layers 110, must have a bearing resistance of predetermined strength or more because it serves as a support of the carrier 100, and can be patterned to form a second circuit pattern 135 (refer to FIG. 5). Therefore, each of the second metal layers 130 may also be made of copper.

The two insulation layers 120, each of which is provided on one side thereof with the first metal layer 110 and on the other side thereof with the second metal layer 130, are attached to each other by the third metal layer 140. Here, the material of each of the insulation layers 120 is not particularly limited. However, since each of the insulation layers 120 can be used as an insulation layer 120 (refer to FIG. 10) of a substrate after the carrier 100 is separated, each of the insulation layers 120 may be formed of prepreg to manufacture a thinner printed circuit board or may be formed of ABF (Ajinomoto Build up Film) to realize a microcircuit. In addition, a copper clad laminate (CCL) may be used as each of the insulation layers 120. In this case, the copper foils applied on both sides of the copper clad laminate (CCL) serve as the first metal layer 110 and the second metal layer 130, respectively. Further, each of the insulation layers 120 may be formed by adding a reinforcing material, such as paper, glass fiber, non-woven glass fabric or the like, to a resin in order to improve the mechanical strength of the carrier 100.

The third metal layer 140 serves to maintain the entire conjunction of the carrier 100 by attaching the first metal layers 110 to each other. Here, the third metal layer 140 may be made of tin or a tin alloy, or may be made of any one selected from the group consisting of tin, cadmium, lead, bismuth, zinc, and alloys or combinations thereof. Further, the third metal layer 140 may be formed between the first metal layers 110 by a plating process, or may be formed between the first metal layers 110 by attaching metal foil onto the first metal layers 110 through heating and pressing processes. In this case, the third metal layer 140 reacts with the first metal layers 110 to form intermetallic compound layers 145. For example, when the first metal layers 110 are made of copper and the third metal layer 140 is made of tin, intermetallic compound layers 145, such as Cu₆Sn₅, Cu₃Sn or the like, are formed between the first metal layers 110 and the third metal layer 140. However, in order to separate the carrier 100 at constant temperature, the third metal layer 140 must not be entirely converted into the intermetallic compound layers 145, and a pure third metal layer 140 having a constant melting point must remain. As described above, since tin has a melting point of about 232° C., when the third metal layer 140 is made of tin, the carrier 100 for manufacturing a substrate can be separated by heating it to a temperature of 232° C. or higher. Therefore, the present invention, differently from conventional technologies, is advantageous in that a routing process can be omitted, and in that the carrier 100 can be stably maintained at about 200° C. generally reached during a process of manufacturing a substrate.

FIGS. 3 to 10 are sectional views sequentially showing a method of manufacturing a substrate using the carrier according to an embodiment of the present invention.

As shown in FIGS. 3 to 10, a method of manufacturing a substrate using the carrier according to an embodiment of the present invention includes: providing two insulation layers 120, each being provided on one side thereof with a first metal layer 110 and on the other side thereof with a second metal layer 130; forming a third metal layer 140 having a lower melting point than the first metal layer 110 between the two first metal layers 110 respectively formed on the two insulation layers 120 such that the two first metal layers 110 are attached to each other, so as to provide a carrier 100; forming a build up layers 150 on the exposed surface of the second metal layer 130; and heating the third metal layer 140 to its melting point or higher to separate the carrier 100. The method of manufacturing a substrate using the carrier may further include: patterning the second metal layer 130 to form a second circuit pattern 135 after the providing of the carrier 100; and forming a first circuit pattern 115 on one side of the insulation layer 120 after the separating of the carrier 100.

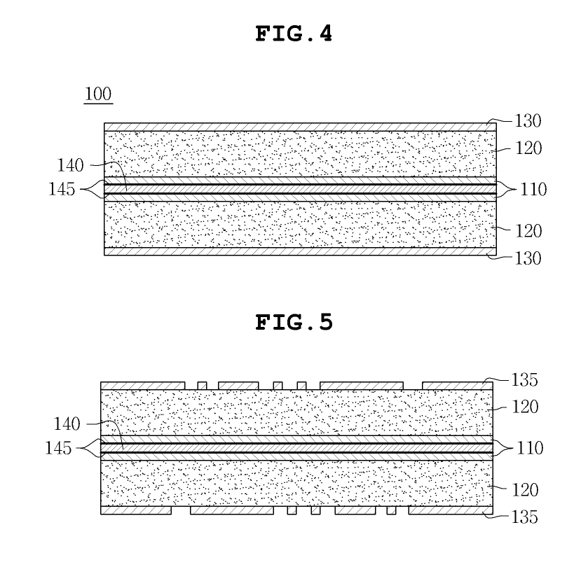

First, as shown in FIGS. 3 and 4, two insulation layers 120, each being provided on one side thereof with a first metal layer 110 and on the other side thereof with a second metal layer 130, are provided and then attached to each other using a third metal layer 140. Here, the first metal layer 110 may be made of copper, nickel or aluminum, and the insulation layer 120 may be formed of prepreg or ABF (Ajinomoto Build up Film). Further, a copper clad laminate (CCL) may be used as the insulation layers 120. In this case, the copper foils applied on both sides of the copper clad laminate (CCL) serve as the first metal layer 110 and the second metal layer 130, respectively. Further, the third metal layer 140 may be made of tin or a tin alloy, or may be made of any one selected from the group consisting of tin, cadmium, lead, bismuth, zinc, and alloys or combinations thereof.

Meanwhile, a procedure for attaching the first metal layers 110 to each other may be performed by the following four processes.

First, third metal layers 140 are plated on the two first metal layers 110 formed on the two insulation layers 120, respectively (refer to FIG. 3A), and then the exposed surfaces of the third metal layers 140 are brought into contact with each other and then heated and pressed to form the third metal layer 140 between the first metal layers 110 (refer to FIG. 4).

Second, foil-shaped third metal layers 140 are applied on the two first metal layers 110 formed on the two insulation layers 120 by heating and pressing them, respectively (refer to FIG. 3A), and then the exposed surfaces of the third metal layers 140 are brought into contact with each other and then heated and pressed to form the third metal layer 140 between the first metal layers 110 (refer to FIG. 4).

Third, a third metal layer 140 is plated on any one of the two first metal layers 110 formed on the two insulation layers 120 (refer to FIG. 3B), and then the exposed surface of the third metal layer 140 is brought into contact with the exposed surface of the first metal layer 110, which is not plated with the third metal layer 140, and then heated and pressed to form the third metal layer 140 between the first metal layers 110 (refer to FIG. 4).

Fourth, a foil-shaped third metal layer 140 is applied on any one of the two first metal layers 110 formed on the two insulation layers 120 by heating and pressing it (refer to FIG. 3B), and then the exposed surface of the third metal layer 140 is brought into contact with the exposed surface of the first metal layer 110, which is not plated with the third metal layer 140, and then heated and pressed to form the third metal layer 140 between the first metal layers 110 (refer to FIG. 4).

Through the above four processes, the two insulation layers 120, each being provided on one side thereof with the first metal layer 110 and on the other side thereof with the second metal layer 130, are attached to each other using the third metal layer 140 to provide a completed carrier 100 (refer to FIG. 4). Meanwhile, as described above, the third metal layer 140 reacts with the first metal layers 110 to form intermetallic compound layers 145 between the third metal layer 140 and the first metal layers 110.

Subsequently, as shown in FIG. 5, the second metal layers 130 are patterned to form second circuit patterns 135. The second metal layers 130 serve to prevent the carrier 100 from warping. Further, the second metal layers 130 are formed into the second circuit patterns 135 in this process to be used as inner circuit layers of a substrate. In this case, the second circuit patterns 135 may be formed using a Semi-Additive Process (SAP) or a Modified Semi-Additive Process (MSAP) or a subtractive process.

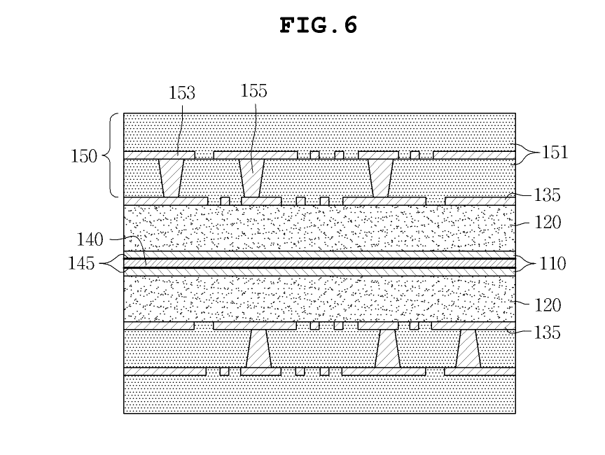

Subsequently, as shown in FIG. 6, a build up layer 150 is formed on the exposed surface of each of the second metal layers 130. Here, the build up layer 150 can be completed by applying an insulating material 151 onto each of the second metal layers 130, forming via holes in the insulating material 151 using an YAG or CO₂ laser and then forming a circuit layer 153 including vias 155 on the insulating material 151 through a Semi-Additive Process (SAP) or a Modified Semi-Additive Process (MSAP).

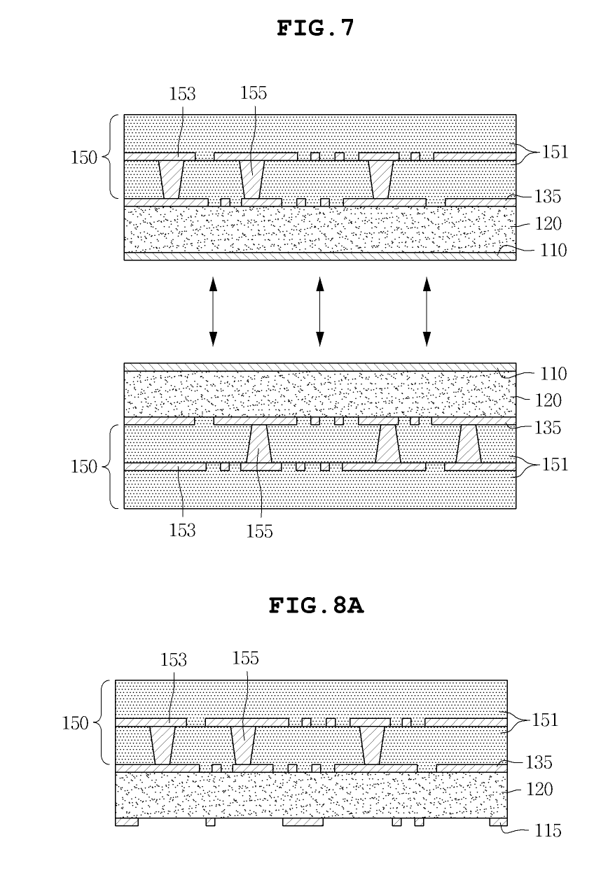

Subsequently, as shown in FIG. 7, the third metal layer 140 is heated to its melting point or higher to separate the carrier 100. As described above, the third metal layer 140 has a melting point ranging from about 232° C. to about 419° C., whereas the first metal layer 110 has a melting point ranging from about 660° C. to about 1455° C. Therefore, the carrier 100 is heated to a predetermined temperature (for example, a temperature ranging from 419° C. or more to less than 660° C.) to selectively melt only the third metal layer 140, thus separating the carrier 100. In this case, physical force may be additionally applied thereto in order to more efficiently separate the carrier 100.

Meanwhile, when the carrier 100 is separated, the insulation layer 120 is used as an outermost insulation layer of a substrate. Further, after the carrier 100 is separated, the third metal layer 140 remaining on the first metal layer 110 may be removed by an etching process.

Subsequently, as shown in FIGS. 8 and 9, a first circuit pattern 115 is formed on the insulation layer 120. In this case, a procedure for forming the first circuit pattern 115 on the insulation layer 120 may be performed by the following two processes.

First, the first circuit pattern 115 may be formed on the insulation layer 120 by patterning the first metal layer 110 (refer to FIG. 8A). In this case, since the first metal layer 110 is used to form the first circuit pattern 115, an additional plating process can be omitted, thus simplifying a manufacturing process.

Second, the first circuit pattern 115 may be formed on the insulation layer 120 by removing the first metal layer 110 (refer to FIG. 8B) and then performing a plating process (refer to FIG. 9). In this case, although an additional plating process must be performed, flexibility of circuit design, such as easiness of via formation or the like, can be improved.

Here, the first circuit pattern 115 may be formed using a Semi-Additive Process (SAP) or a Modified Semi-Additive Process (MSAP) or a subtractive process.

Subsequently, as shown in FIG. 10, a solder resist layer 160 is formed on one side of the insulation layer 120. Here, the solder resist layer 160 is made of a heat-resistant coating material, and serves to protect the first circuit pattern 115 such that solder is not applied onto the first circuit pattern 115 during soldering. Further, in order to electrically connect the first circuit pattern 115 with external circuits, openings 165 may be formed in the solder resist layer 160 to expose pads.

Meanwhile, as shown in FIGS. 9 and 10, when the first circuit pattern 115 and the solder resist layer 160 are formed on one side of the insulation layer 120, a circuit layer 170 and a solder resist layer 180 can also be formed even on the outermost layer of the build up layer 150 located opposite the insulation layer 120. Therefore, the same processes are simultaneously performed on both sides of a substrate, thus simplifying a process of manufacturing a substrate.

As described above, according to the present invention, the carrier can be separated by heating, so that a routing process is not required, with the result that the size of a substrate does not change at the time of separating the carrier, thereby maintaining the compatibility between a substrate and manufacturing facilities.

Further, according to the present invention, the components of the carrier can be used as the outermost insulation layer and circuit pattern of a finally-produced printed circuit board, thus reducing the production cost of the printed circuit board.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. A carrier for manufacturing a substrate, comprising:
two insulation layers, each being provided on one side thereof with a first metal layer and on the other side thereof with a second metal layer; and
a third metal layer having a lower melting point than the first metal layer and formed between the two first metal layers respectively formed on the two insulation layers such that the two first metal layers are attached to each other.

2. The carrier for manufacturing a substrate according to claim 1, wherein the third metal layer is made of tin or an tin alloy.

3. The carrier for manufacturing a substrate according to claim 1, wherein the third metal layer is made of any one selected from the group consisting of tin, cadmium, lead, bismuth, zinc, and alloys or combinations thereof.

4. The carrier for manufacturing a substrate according to claim 1, wherein the first metal layer is made of copper, nickel or aluminum.

5. The carrier for manufacturing a substrate according to claim 1, wherein the insulation layer is formed of prepreg or ABF (Ajinomoto Build up Film).

6. The carrier for manufacturing a substrate according to claim 1, wherein intermetallic compound layers are formed between the third metal layer and the first metal layers.

7. A method of manufacturing a substrate using a carrier, comprising:
providing two insulation layers, each being provided on one side thereof with a first metal layer and on the other side thereof with a second metal layer;
forming a third metal layer having a lower melting point than the first metal layer between the two first metal layers respectively formed on the two insulation layers such that the two first metal layers are attached to each other, so as to provide a carrier;
forming a build up layer on the exposed surface of the second metal layer; and
heating the third metal layer to its melting point or higher to separate the carrier.

8. The method of manufacturing a substrate using a carrier according to claim 7, wherein, in the forming of the third metal layer, the third metal layer is made of tin or a tin alloy.

9. The method of manufacturing a substrate using a carrier according to claim 7, wherein, in the forming of the third metal layer, the third metal layer is made of any one selected from the group consisting of tin, cadmium, lead, bismuth, zinc, and alloys or combinations thereof.

10. The method of manufacturing a substrate using a carrier according to claim 7, further comprising:
removing the third metal layer remaining on the first metal layers after the separating of the carrier.

11. The method of manufacturing a substrate using a carrier according to claim 7, further comprising:
patterning the first metal layer to form a first circuit pattern after the separating of the carrier.

12. The method of manufacturing a substrate using a carrier according to claim 7, further comprising:
removing the first metal layer and then forming a first circuit pattern through a plating process after the separating of the carrier.

13. The method of manufacturing a substrate using a carrier according to claim 7, further comprising:
patterning the second metal layer to form a second circuit pattern after the forming of the third metal layer.

14. The method of manufacturing a substrate using a carrier according to claim 7,
wherein the forming of the third metal layer comprises:
plating the third metal layers on the two first metal layers formed on the two insulation layers, respectively; and
heating and pressing the third metal layers plated on the two first metal layers to attach them to each other, thereby providing the carrier.

15. The method of manufacturing a substrate using a carrier according to claim 7,
wherein the forming of the third metal layer comprises:
plating the third metal layer on any one of the two first metal layers formed on the two insulation layers; and
heating and pressing the third metal layer plated on one first metal layer and the other first metal layer to attach them to each other, thereby providing the carrier.

16. The method of manufacturing a substrate using a carrier according to claim 7,
wherein the forming of the third metal layer comprises:
heating and pressing the foil-shaped third metal layers to apply them on the two first metal layers formed on the two insulation layers; and
heating and pressing the third metal layers applied on the two first metal layers to attach them to each other, thereby providing the carrier.

17. The method of manufacturing a substrate using a carrier according to claim 7,
wherein the forming of the third metal layer comprises:
heating and pressing the foil-shaped third metal layer to apply it on either of the two first metal layers formed on the two insulation layers; and
heating and pressing the third metal layer applied on one first metal layer and the other first metal layer to attach them to each other, thereby providing the carrier.

18. The method of manufacturing a substrate using a carrier according to claim 7, wherein, in the providing of the two insulation layers, the first metal layer is made of copper, nickel or aluminum.

19. The method of manufacturing a substrate using a carrier according to claim 7, wherein, in the providing of the two insulation layers, the first metal layer is formed of prepreg or ABF (Ajinomoto Build up Film).

20. The method of manufacturing a substrate using a carrier according to claim 7, wherein, in the forming of the third metal layer, intermetallic compound layers are formed between the third metal layer and the first metal layers.
